(19) United States
(12) Patent Application Publication
(10) Pub. No.: US 2008/0084626 A1
(43) Pub. Date: Apr. 10, 2008

(54) LIGHTING REFLECTOR AND METHOD OF MAKING THE SAME

(76) Inventor: Robert F. Blood, Dayton, OH (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/539,235

(22) Filed: Oct. 6, 2006

(51) Int. Cl. G02B 5/08

(52) U.S. Cl. 359/883; 359/838

(57) ABSTRACT

A reflector for use in a lighting device includes a reflector support having inner and outer surfaces. A reflective material is fused with the inner surface of the reflective support. There is also disclosed a method of forming a lighting reflector including the steps of providing a forming tool, positioning a reflective material in the forming tool, positioning a reflector support having inner and outer surfaces proximate the reflective material, and then actuating the forming tool wherein the reflective material is fused to the reflector support.

### FIELD OF THE INVENTION

The invention relates to lighting reflectors and methods of forming lighting reflectors.

### BACKGROUND OF THE INVENTION

Lighting reflectors are known in the art and may include a single-piece design that is fabricated out of a reflective material using a molding or other forming operation. A drawback with one-piece reflectors fabricated using a forming operation includes the need for secondary operations to place a reflective finish on the reflector leading to an overall higher cost for a lighting reflector.

It is also known in the art to use separate reflectors that may be fabricated from multiple sheets of reflective material that have been assembled together to form a reflector shape. The individual components of the multipiece reflector may be joined using fastening devices or other suitable connection schemes such as tabs and slots. Such multi-piece reflectors are typically mounted within a housing to form a lighting reflector assembly. A drawback with such multipiece reflectors is that the position of the reflective surface is subject to change due to possible movement of the reflective pieces within the housing or from tolerances when assembling the reflector assembly. There is therefore a need in the art for a reflector that is low in cost in comparison to prior art reflector assemblies and has the ability to maintain the reflective surface in a desired orientation. Additionally there is a need in the art for a reflector assembly that can be formed in a single manufacturing operation.

### SUMMARY OF THE INVENTION

A reflector for use in a lighting device includes a reflector support having inner and outer surfaces. A reflective material is fused with the inner surface of the reflective support.

There is also disclosed a method of forming a lighting reflector including the steps of providing a forming tool, positioning a reflective material in the forming tool, positioning a reflector support proximate the reflective material, and then actuating the forming tool wherein the reflective material is fused to the reflector support.

### BRIEF DESCRIPTION OF THE DRAWINGS

FIG. 1 is a perspective view detailing the inside of a lighting reflector including a reflector support and reflective material fused on the inner surface of the reflective support;

FIG. 2 is a perspective view of a lighting reflector detailing an outer surface of the reflector support;

FIG. 3 is a partial perspective view detailing the step of positioning a reflective material in a forming tool;

FIG. 4 is a partial perspective view detailing the step of positioning a reflector support proximate the reflective material; and

FIG. 5 is a partial perspective view following actuation of the forming tool wherein the reflective material is fused to the reflector support.

### DETAILED DESCRIPTION OF THE PREFERRED EMBODIMENTS

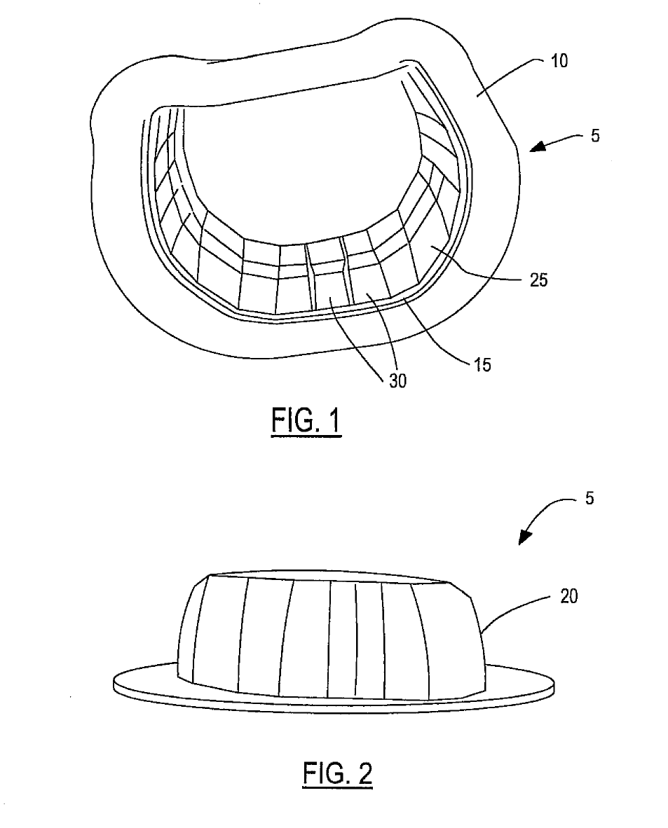

Referring to FIGS. 1 and 2, there is shown a reflector 5 for use in a lighting device. The reflector 5 includes a reflector support 10 having inner and outer surfaces 15, 20. Additionally the reflector 5 includes a reflective material 25 that is fused with the inner surface 15 of the reflective support 10.

The reflective material 25 may include a plurality of reflector segments 30. The reflector segments 30 may be individual pieces or may be formed of a strip or film having multiple facets. In one aspect of the invention, the plurality of reflector segments 30 are permanently fixed in a desired orientation relative to the reflector support 10. In this manner, the reflector segments 30 are not subject to movement and can maintain a desired position; thereby scattering light from a lighting device in an efficient manner.

In one aspect of the invention, the reflector support 10 is formed of a different material than the reflective material 25. The reflector support 10 may be formed of a suitable metal material such as aluminum. The reflective material 25 may be formed of a prefinished material that has desirable light scattering properties. Suitable prefinished materials include anodized aluminum, coated metal, and metal having a layer deposited thereon. Through the use of two different materials in the reflective support 10 and reflective material 25, cost savings can be realized over prior art designs formed completely of a reflective material. Additionally, as stated above, prior art reflectors formed from a single piece of reflective material often require secondary operations to add a reflective coating or surface to the material following a forming operation that is not required with the present invention.

Also disclosed is a method of forming a lighting reflector 5 that includes the steps of providing a forming tool 35, positioning a reflective material 25 in the forming tool 35, positioning a reflector support 10 proximate the reflective material 25, and actuating the forming tool 35 wherein the reflective material 25 is fused to the reflector support 10.

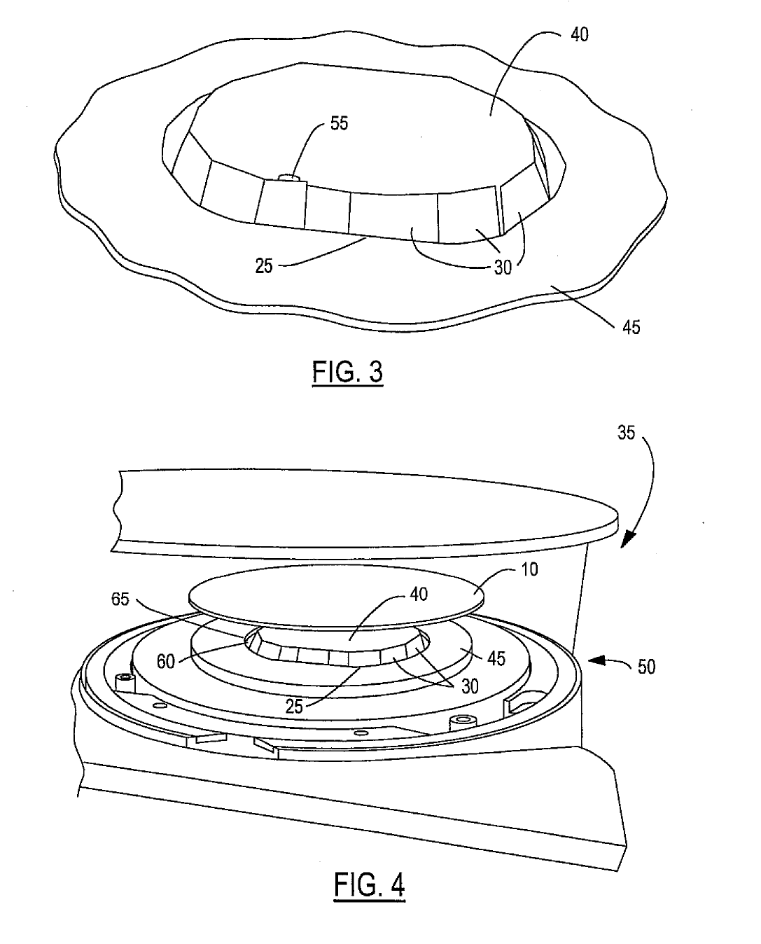

In one aspect of the invention, the forming tool 35 may be a hydroforming tool having a punch 40, draw ring 45, and forming chamber 50. Referring to FIG. 3, there is shown a first step of positioning a reflective material 25 about the forming tool 35. In this depiction, the reflective material 25 is positioned about a punch 40 of a hydroforming tool. The punch 40 includes a reflective material locator 55 for positioning the reflective material 25 relative to the punch 40. In one aspect of the invention, the locator 55 may be a pin type alignment system that facilitates fusion of the reflective material 25 with the reflective support 10.

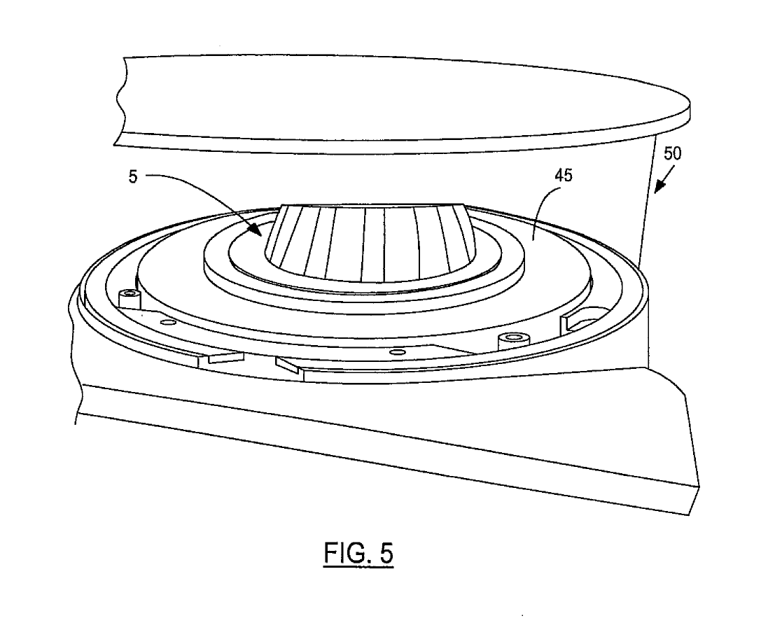

After positioning the reflective material 25 about the punch 40, the reflector support 10 is then positioned on top of the punch 40, as shown in FIG. 4. While the reflector support 10 shown in FIG. 4 is a flat circular blank of material, it should be realized that any suitable shape or blank may be utilized by the invention. Additionally, the reflector support 10 may be preformed into various shapes and configurations prior to positioning about the reflective material 25 on the punch 40.

Following the positioning of the reflector support 10, a forming chamber 50 of the hydroforming tool is closed and a pressure is applied to the chamber. Next the punch 40 is moved upward wherein the reflector support 10 is drawn about the punch 40 and draw ring 45 of the hydroforming tool such that the reflective material 25 is fused to the reflector support 10.

The starting or precharging pressures may vary and can be determined by the shape, width, depth and material thicknesses of the various components of the reflector. The forming punch 40 of the hydroforming tool may be made from any metal alloy, epoxy, various sintered or nonsintered composites, polyimide, various polymers including copolymer acetyls, or any grade of Torlon, Kevlar or urethanes. The punch 40 should be highly polished to allow for a smooth inside surface of the reflector 5. The draw ring 45 of the hydroforming tool may be made from various metal materials that have been highly polished. The draw ring 45 should have a hole 60 cut in it with dimensions equaling approximately the sum of both material thicknesses of the reflective material 25 and reflector support 10. In other words the hole 60 should be positioned a distance from the punch 40 approximating the material thicknesses of the reflector support 10 and reflective material 25. The hole 60 formed in the draw ring 45 should match the outside shape of the punch 40 and may include a radius 65 that allows the material of the reflector support 10 to slide without scratching during the forming operation.

In one aspect of the invention, only the reflector support 10 is drawn across the draw ring 45 when the forming tool 35 is actuated such that the finish on the prefinished reflective materials 25 is maintained following the forming operation. In another aspect, the section of the reflector support material 10 proximate the reflective material 25 should be prevented from receiving lubrication to enhance the fusion of the reflective material 25 to the reflector support 10 during the forming operation.

The punch 40 of the hydroforming tool is preferably set at a starting height that allows for a minimal shock line but is positioned low enough such that wrinkles are not developed. Various forming cycles may be utilized by the forming tool dependent upon the shape, width, depth and material thicknesses of the various materials of the reflector 5. In one aspect, a controlled forming cycle may be utilized while in other applications a natural cycle may be used.

The reflector support 10 may be positioned in various locations relative to the punch 40 and reflective material 25. For example, the reflector support 10 may be centered about the reflective material 25 or could be off centered or offset to produce various other configurations of reflectors 5.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A reflector for use in a lighting device comprising:
a reflector support having inner and outer surfaces; and
a reflective material fused with the inner surface of the reflective support.

2. The reflector of claim 1 wherein the reflective material includes a plurality of reflector segments.

3. The reflector of claim 2 wherein the plurality of reflector segments are permanently fixed in a desired orientation relative to the reflector support.

4. The reflector of claim 1 wherein the reflector support is formed of a different material than the reflective material.

5. The reflector of claim 4 wherein the reflector support is formed of aluminum.

6. The reflector of claim 4 wherein the reflective material is formed of a prefinished material.

7. The reflector of claim 6 wherein the prefinished material is selected from anodized aluminum, coated metal, and metal having a layer deposited thereon.

8. A reflector for use in a lighting device comprising:
a reflector support formed of a first material and having inner and outer surfaces; and
a reflective material formed of a second material differing from the first material, the reflective material fused with the inner surface of the reflective support.

9. A method of forming a lighting reflector comprising the steps of:
a) providing a forming tool;
b) positioning a reflective material in the forming tool;
c) positioning a reflector support proximate the reflective material;
d) actuating the forming tool wherein the reflective material is fused to the reflector support.

10. The method of claim 9 wherein the forming tool is a hydroforming tool having a punch, drawing, and forming chamber.

11. The method of claim 10 wherein the reflective material is positioned about the punch and the reflector support is positioned on top of the punch.

12. The method of claim 10 wherein the punch includes a reflective material locator for positioning the reflective material relative to the punch.

13. The method of claim 12 wherein the locator is a pin type alignment system.

14. The method of claim 10 wherein step d) includes:
e) closing the forming chamber;
f) applying a pressure to the chamber;
g) moving the punch upward wherein the reflector support is drawn about the punch and the reflective material is fused to tie reflector support.

15. The method of claim 10 wherein the draw ring includes a hole positioned from the punch a distance approximating the sum of a material thickness of the reflector support and the reflective material.

16. The method of claim 15 wherein the hole includes a radius for allowing movement of the reflector support without scratching.

17. The method of claim 15 wherein the hole has a shape corresponding to the shape of the punch.

18. The method of claim 10 wherein only the reflector support is drawn across the drawing.

19. The method of claim 9 wherein the reflector support is preformed.

20. The method of claim 9 wherein a section of the reflector support proximate the reflective material is not lubricated.
